(19) United States
(12) Patent Application Publication
(10) Pub. No.: US 2011/0209684 A1
(43) Pub. Date: Sep. 1, 2011

(54) SONIC SYSTEM AND METHOD FOR PRODUCING LIQUID-GAS MIXTURES

(75) Inventors: Mark Veinblat, Haifa (IL); Yoram Zvirin, Haifa (IL); Leonid Tartakovsky, Haifa (IL); Marcel Gutman, Nesher (IL); Vladimir Baibikov, Haifa (IL)

(73) Assignee: Technion-Research & Development Foundation Ltd, Haifa (IL)

(21) Appl. No.: 12/935,690

(22) PCT Filed: Mar. 22, 2009
(86) PCT No.: PCT/IL09/00319

§ 371 Date: Apr. 27, 2011

Related U.S. Application Data
(60) Provisional application No. 61/041,104, filed on Mar. 31, 2008.

(51) Int. Cl. F02M 57/00; B01F 3/04; B01F 11/02

(52) U.S. Cl. 123/294; 261/119.1; 261/76; 366/108

(57) ABSTRACT

A sonic saturation system is provided that comprises at least one tank for containing a reservoir of liquid solvent; at least one gas-inlet in fluid communication with a gas compressor, for introducing gaseous solute into the reservoir, and at least one sonic agitator (146) for agitating the liquid reservoir thereby increasing the rate of impregnation of the solute into the solvent.

### FIELD OF THE INVENTION

The present invention relates to a system and method for producing mixtures of gases and liquids. In particular the invention relates to the mixing of fuel and air in an internal combustion engine.

### BACKGROUND

In light-fuel spark ignition (SI) internal combustion engines, a fuel-air mixture is formed by a carburetor in which a liquid fuel, such as gasoline, is vaporized in the presence of air from the atmosphere. A variant of this, commonly used in contemporary SI engines is the creation of a fuel-air mixture by injecting, atomizing and evaporating fuel in an intake manifold or directly into an engine cylinder. The fuel-air mixture is drawn into a combustion chamber and ignited to drive the engine crankshaft.

Heavy-fuels, such as diesel fuel or kerosene, are typically less volatile than light-fuels and are not easily vaporized. Consequently, in heavy-fuel engines air is generally drawn directly into the cylinders and fuel is injected directly into the air-filled combustion chamber. In the case of compression ignition (CI) engines, high-quality fuel atomization and evaporation are reached by extremely high injection pressure (up to 200 MPa) and in-cylinder air temperature (greater than 500° C.). Such conditions are not practical in heavy-fuel SI engines and various methods have been proposed for improving the formation of the fuel-air mixture for use in heavy-fuel SI engines. Generally, however, these involve additional engine components, which complicate the engine design and increase its weight.

For example, one current method for improving fuel-air mixture in heavy-fuel SI engines is preheating the fuel to increase its vaporization, which requires a high power heat source to be added to the engine. Another known method for improving the fuel-air mixture is use of a two phase fuel injection process in which the fuel is premixed with additional portion of air in an extra chamber before the mixture is injected into the combustion chamber.

In still other fuel injection systems, the fuel is saturated with air before being injected into the combustion chamber. The air-saturated fuel is injected into the lower pressure environment of the combustion chamber, where the dissolved air comes out of solution improving the fuel atomization, evaporation and combustion. Such systems generally require many additional components such as a saturation chamber, diffusion chamber, air compressor as well as multiple pilot valves.

One example of a fuel-saturation system is described in U.S. Pat. No. 6,273,072, to Knapstein and Jones, titled “Fuel system apparatus and method”. '072 describes a combustion engine fuel system which saturates and diffuses a gas into a liquid fuel. The apparatus described by Knapstein and Jones includes a fuel saturation chamber connected to both the engine's fuel tank and a gas compressor, for directing compressed gas into the fuel saturation chamber. The fuel saturation chamber is further connected to a gas diffusion chamber, containing a dense porous material for diffusing gas into the liquid fuel, and which is also connected to the gas compressor. It will be appreciated that the proliferation of chambers, together with the valves and pipes necessary to connect them, greatly complicates the engine's apparatus.

Due to the differences in properties of light and heavy fuels, such as those described above, it is currently very difficult to convert a light-fuelled internal combustion SI engine to run on heavy-fuels particularly as the latter require significant complications to the engine design.

There is therefore a need for an improved system and method for the formation of a gas-liquid mixture, such as the combustible mixture used in the cylinders of heavy-fuel engines, and the present invention addresses this need.

### SUMMARY OF THE INVENTION

In accordance with a first embodiment, the present invention is directed to providing a sonic saturation system comprising: at least one tank for containing a reservoir of liquid solvent; at least one gas-inlet, in fluid communication with a gas compressor, for introducing gaseous solute into said reservoir, and at least one sonic agitator for agitating said liquid reservoir thereby increasing the rate of impregnation of said solute into said solvent. Typically, the sonic agitator comprises an ultrasonic vibrator.

In some embodiments, the sonic saturation system further comprises at least one injector pipe for ejecting a spray of solution from said reservoir. Optionally, the spray is injected into a chamber. Typically, the ambient pressure of said chamber is lower than the pressure of the liquid reservoir such that dissolved gas comes out of solution.

In accordance with another embodiment, the present invention is directed to providing an internal combustion engine incorporating the sonic saturation system wherein the chamber comprises a combustion chamber. Typically, the solvent comprises a fuel and optionally, the solute comprises air.

In other embodiments, the sonic system comprises a controller for controlling the sonic agitator thereby controlling the rate of impregnation of said solute into said solvent. Optionally, the controller further controls the gas compressor.

According to various embodiments the solvent comprises at least one of the group consisting of: gasoline, diesel fuel, kerosene, bio-fuels, water and liquid paints. Optionally, the solute comprises at least one of the group consisting of: air, hydrogen, a hydrocarbon, carbon dioxide and nitrogen.

In accordance with still another embodiment, the present invention is directed to teaching a method for mixing gases and liquids, said method comprising the steps: step (a) providing at least one reservoir of liquid solvent; step (b) introducing gaseous solute into said reservoir, and step (c) agitating said reservoir with sonic waves thereby increasing the rate of impregnation of said solute into said solvent.

Optionally, step (c) of agitating said reservoir with sonic waves comprises transmitting ultrasonic waves into said reservoir.

Optionally, the method includes a further step, step (d) of ejecting a spray of solution from said reservoir.

Typically, the liquid solvent comprises a fuel and said gaseous solute comprises air.

The term ‘saturation’ and its variations are used herein to refer to the process of charging a liquid with a gas. The team may be used, for example, to refer to the dissolving of a gas, for example, air, hydrogen or the other gases into a liquid fuel.

The term ‘diffusion’ and its variations are used herein to refer to the process of disseminating a gas into a liquid.

The term ‘supersaturation’ is used herein to refer to a state of solution which is more highly concentrated than is possible under given conditions.

The term ‘atomize’ and its variations are used herein to refer to the process of reducing a liquid to a spray of fine droplets.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic representation of a sonic saturation system for producing mixtures of gases and liquids according to a first embodiment of the invention;

FIG. 2 is a block diagram showing the main components of an internal combustion engine incorporating a sonic saturation system according to another embodiment of the invention, and

FIG. 3 is a flowchart representing a method for mixing gasses and liquids according to a further embodiment of the invention.

### DESCRIPTION OF THE PREFERRED EMBODIMENTS

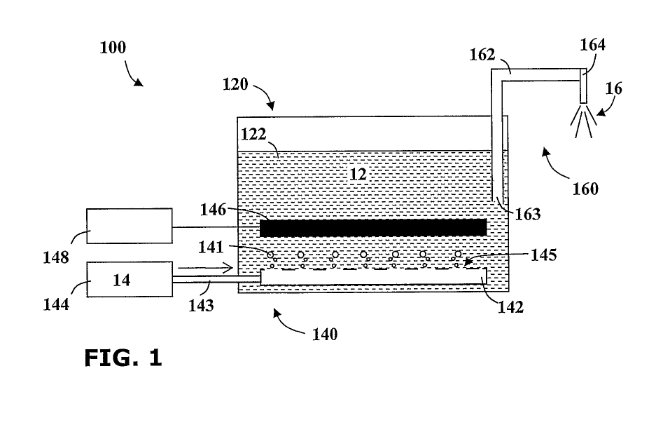

Reference is now made to FIG. 1 showing a schematic representation of a sonic saturation system 100 for producing mixtures of gases and liquids according to a first embodiment of the invention. The system 100 consists of: a) a tank 120, for containing a reservoir 122 of liquid 12, b) a gas delivery apparatus 140, for impregnating the liquid 12 with a gas 14, and c) an atomizer 160 for dispensing a spray 16 consisting of small droplets of the liquid with the gas dissolved therein.

It is a particular feature of embodiments of the current invention that the gas delivery apparatus 140 includes a gas-inlet 142 and a sonic agitator 146.

The gas-inlet 142 is in fluid communication with a gas compressor 144 via a gas-line 143. The gas compressor 144 is configured to supply pressurized gas to perforations 145, through which bubbles 141 of the gas 14 may be introduced into the reservoir 122.

The sonic agitator 146 is coupled to a sonic transducer 148 and is configured and operable to produce sonic waves within the liquid medium concurrently with the introduction of gas bubbles 141 via the gas-inlet 142. The sonic agitation thus produced enhances diffusion and dissolution of the gas 14 into the liquid 12 thereby increasing the impregnation rate of the gas 14 into the liquid 12.

The rate of dissolution of a solute in a solvent is governed by the formula:

$$- \frac{d {C}_{A}}{d t} = {k}_{sl} a ( {C}_{A}^{*} - {C}_{A} )$$

where: C_{A} is the concentration of the solute, C*_{A} is the concentration of a saturated solution of the solute in the solvent under normal conditions,

$$- \frac{d {C}_{A}}{d t}$$

is the rate of dissolution, k_{sI} is the intrinsic mass transfer constant, a is the interfacial area and (C*_{A}−C_{A}) is the driving force of the dissolution.

It has been demonstrated that sonic waves transmitted through a solvent at an ultrasonic frequency of 20 kHz induce the supersaturation of the solute, so that the saturation concentration C*_{A} is effectively greater than that under normal conditions. Thus the driving force of the dissolution (C*_{A}-C_{A}) is a function of the sonic agitation of the solvent.

In embodiments of the current invention, sonic agitation of the liquid reservoir 12 is used to increase the rate of dissolution of a gaseous solute 14 into a liquid solvent 12. Furthermore the rate of dissolution of the solvent may be further increased because the agitation of the liquid may divide the gas bubbles 141 into smaller units, thereby increasing the interfacial area between the gas and the liquid.

The atomizer 160 consists of a conduit 162, the mouth 163 of which is immersed in the reservoir 122. When gas is introduced into the reservoir 122 through the gas-inlet 142, the increased pressure of the reservoir 122 forces the liquid 12 into the mouth 163 of the conduit 162. The liquid is forced through the conduit 162 to a nozzle 164 at its distal end, out of which the liquid is ejected in the form of a spray 16.

Typically, the ambient pressure outside the nozzle 164 is lower than the pressure of the reservoir 122. Due to these low ambient pressure conditions and the relatively large surface area of the liquid droplets of the spray 16, gas dissolved in the liquid droplets tends to come out of solution. This increases the atomization of the liquid and produces a vaporous mixture of the gas and the liquid.

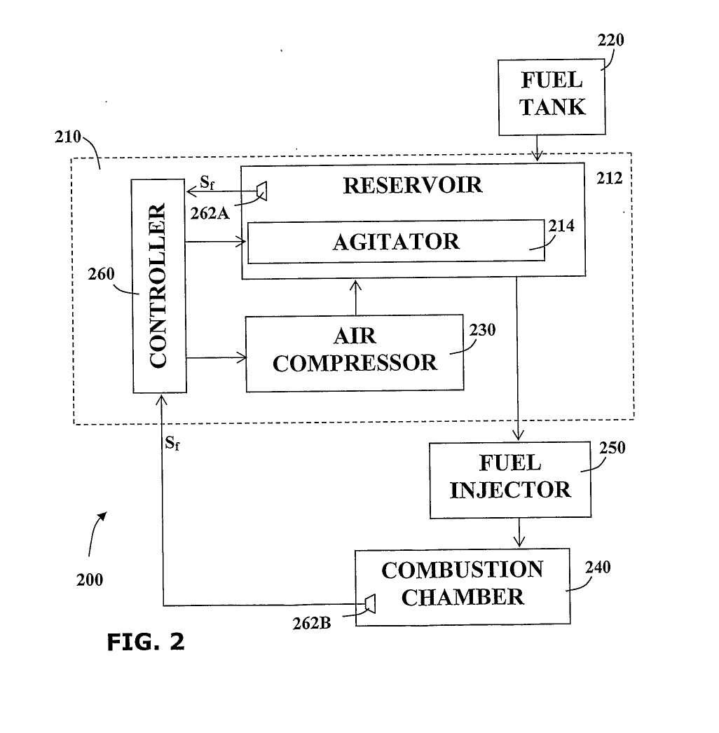

Reference is now made to FIG. 2 which is a block diagram representing the main components of an internal combustion engine 200 incorporating a sonic saturation system 210 according to another embodiment of the invention. The engine 200 includes a fuel-tank 220, an air compressor 230, a fuel injector 250 and a combustion chamber 240.

Injecting air-saturated fuel directly into the combustion chamber 240 of the internal combustion engine 200 improves the quality of the fuel-air mixture and therefore the overall efficiency of the engine 200. This is particularly useful in heavy-fuel SI engines, for example running on diesel, kerosene or the like. It is noted, however, that air-saturated fuel injection systems may also be used to improve efficiency in light-fuel engines running, for example, on gasoline and engines with indirect injection.

The sonic saturation system 210 may be used to impregnate the fuel with air. The increased rate of dissolution, resulting from the action of the sonic agitator 214, promotes the diffusion of the air saturated in the fuel within the very short time period, typically between 1-10 milliseconds, during which air is introduced into the fuel reservoir.

Knapstein and Jones, in U.S. Pat. No. 6,273,072, referenced above, present a system which first saturates liquid fuel with air and then increases the diffusion of the saturated liquid fuel passively using a porous stone enclosed within a casing. The system described in '072 requires separate units for the fuel tank, the saturation chamber and the diffusion chamber.

In contradistinction to such prior art systems, embodiments of the present invention provide air-saturated fuels using only the single chamber of the sonic saturation system 210, rather than the separate saturation chamber and diffusion chamber of Knapstein and Jones' system.

In preferred embodiments of the invention, the reservoir 212 of the sonic saturation system serves also as the fuel tank 220, further reducing the number of separate chambers required. Alternatively, fuel from the fuel-tank 220 is drawn into a separate liquid reservoir 212. It is noted that supply of fuel may be controlled by a valve system, typically including a float valve (not shown) monitoring the level of fuel in the reservoir 212.

The atomizer 160 (FIG. 1) of the sonic saturation system 210 may further serve as the fuel injector 250, for introducing a spray containing the fuel-air mixture directly into the combustion chamber 240 of the engine 200. Thus the air compressor 230 may additionally serve as a fuel pump, still further reducing the number of components necessary in the system.

The required fuel-air mixture for a particular engine is dependent upon various conditions such as the engine regime, ambient temperature, pressure, the nature of the fuel used and such like. It is a further feature of certain embodiments of the present invention that the degree of air-saturation may be controlled by the sonic agitator 214 to suit requirements.

According to some embodiments of the invention, a controller 260 is included to monitor and control the operation of the sonic agitator and to optimize the fuel-air mixture formed in the combustion chamber 240.

Optionally, the controller 260 is configured to operate at a predefined level so as to produce a predetermined constitution of fuel-gas mixture. Alternatively, the controller 260 may receive feedback signals S_{f} from sensors 262A, 262B monitoring the contents of the reservoir 212, the combustion chamber 240, other parts of the system or its environment. The controller 260 may be configured to regulate the operation of the sonic agitator 214 and the air compressor 230 based upon these feedback signals S_{f}. It will be appreciated that such control is not possible using a passive diffusion chamber such as described by Knapstein and Jones.

Furthermore, embodiments of the sonic saturation system 210 may be adapted to form mixtures comprising gases other than air, such as methane, hydrogen, carbon dioxide and the like. Moreover, where suitable, multiple gases may be introduced independently through a plurality of gas-inlets.

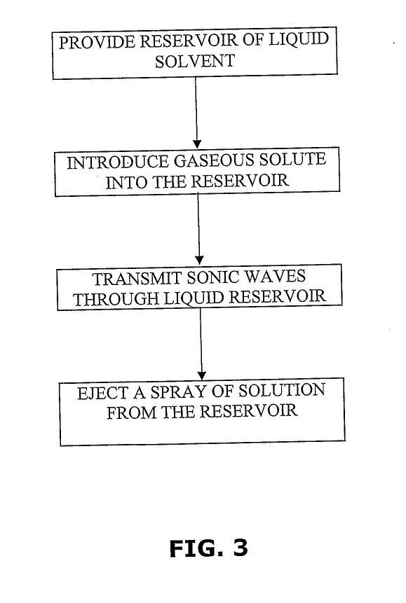

Reference is now made to FIG. 3 showing a flowchart of a method for mixing gasses and liquids according to a further embodiment of the invention. The method includes the steps: providing at least one reservoir of liquid solvent—step (a), introducing gaseous solute into the reservoir—step (b), agitating the reservoir with sonic waves, typically at ultrasonic frequencies,—step (c), and ejecting a spray of solution from the reservoir—step (d).

It is noted that methods for mixing gasses and liquids according to various embodiments of the invention may be used in a variety of applications including but not limited to the internal combustion engine described herein. Other applications include the production of gassed beverages in which gases, typically carbon dioxide, are dissolved into an aqueous solution, spray painting and fuel supply systems for jet engines. Still further applications will occur to the skilled practitioner.

The scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A sonic saturation system comprising:
a. at least one tank for containing a reservoir of liquid solvent;
b. at least one gas-inlet, in fluid communication with a gas compressor, for introducing gaseous solute into said reservoir, and
c. at least one sonic agitator for agitating said liquid reservoir thereby increasing the rate of impregnation of said solute into said solvent.

2. The system of claim 1 wherein said sonic agitator comprises an ultrasonic vibrator.

3. The system of claim 1 further comprising at least one injector pipe for ejecting a spray of solution from said reservoir.

4. The system of claim 3 wherein said spray is injected into a chamber.

5. The system of claim 4 wherein the ambient pressure of said chamber is lower than the pressure of the liquid reservoir such that dissolved gas comes out of solution.

6. An internal combustion engine incorporating the system of claim 4 wherein said chamber comprises a combustion chamber.

7. The internal combustion engine of claim 6 wherein said solvent comprises a fuel.

8. The internal combustion engine of claim 7 wherein said solute comprises air.

9. The system of claim 1 further comprising a controller for controlling the sonic agitator thereby controlling the rate of impregnation of said solute into said solvent.

10. The system of claim 9 wherein said controller further controls the gas compressor.

11. The system of claim 1 wherein said solvent comprises at least one of the group consisting of: gasoline, diesel fuel, kerosene, bio-fuels, water and liquid paints.

12. The system of claim 1 wherein said solute comprises at least one of the group consisting of: air, hydrogen, a hydrocarbon, carbon dioxide and nitrogen.

13. A method for mixing gases and liquids, said method comprising the steps:
step (a)—providing at least one reservoir of liquid solvent;
step (b)—introducing gaseous solute into said reservoir, and
step (c)—agitating said reservoir with sonic waves thereby increasing the rate of impregnation of said solute into said solvent.

14. The method of claim 13 wherein step (c) of agitating said reservoir with sonic waves comprises transmitting ultrasonic waves into said reservoir.

15. The method of claim 13 further comprising step (d)—ejecting a spray of solution from said reservoir.

16. The method of claim 13 wherein said liquid solvent comprises a fuel and said gaseous solute comprises air.
